(19) United States
(12) Patent Application Publication
(10) Pub. No.: US 2024/0316587 A1
(43) Pub. Date: Sep. 26, 2024

(54) SPRAY OR DISPENSING BOTTLE WITH A BOTTOM STORAGE COMPARTMENT

(71) Applicant: Roy Peer, Brandon, FL (US)

(72) Inventor: Roy Peer, Brandon, FL (US)

(21) Appl. No.: 18/529,649

(22) Filed: Dec. 5, 2023

Related U.S. Application Data
(60) Provisional application No. 63/491,293, filed on Mar. 21, 2023.

(51) Int. Cl. B05B 15/00; B65D 25/38

(52) U.S. Cl. CPC B05B 15/00; B65D 25/38

(57) ABSTRACT

A dispensing bottle has a main compartment and a storage compartment, where the storage compartment can be used to store an accessory. the storage compartment can be releasably coupled to the bottom of the main compartment.

### CROSS-REFERENCE TO RELATED APPLICATIONS

This application claims priority from a U.S. provisional patent application Ser. No. 63/491,293 filed on Mar. 21, 2023, which is incorporated herein by reference in its entirety.

### FIELD OF INVENTION

The present invention relates to a spray or dispensing bottle, and more particularly, the present invention relates to a dispensing bottle with a bottom storage compartment.

### BACKGROUND

Spray bottles are widely used both domestically and commercially for dispensing liquid in spray form. Dispensing bottles are used to dispense liquid, wherein liquid flows from the mouth of the dispensing bottle. Both the spray bottle and the dispensing bottle are referred to herein as dispensing bottles. Typically, an accessory accompanies the dispensing bottle, such as a cleaning cloth or a pouch containing some substance. Such an accessory is often attached to the dispensing bottle, for example, using an adhesive. However, during use, the accessory is often misplaced and lost.

A need is therefore appreciated for an improvement in dispensing bottles.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented.

The principal object of the present invention is therefore directed to a dispensing bottle with an isolated storage compartment.

Another object of the present invention is that the accessory can be stored in the compartment.

Still, another object of the present invention is that the risk of misplacing the accessory is avoided.

Yet another object of the present invention is that the accessory is readily available while using the dispensing bottle.

A further object of the present invention is that the dispensing bottle is economical to manufacture.

In one aspect, disclosed is a dispensing bottle comprising a main compartment having a mouth at a top, a closed base, and a wall, wherein the base and the wall define an inner volume of the main compartment; and a storage compartment comprising a closed base, a wall, and an open top, wherein the closed base and the wall define an inner volume of the storage compartment, the storage compartment is configured to be releasably coupled to a bottom of the main compartment using a coupling mechanism, wherein the closed base of the main compartment closes the open top of the storage compartment, the storage compartment is configured to store an accessory. The dispensing bottle further comprises the accessory. The accessory is a roll of cleaning cloth. The dispensing bottle further comprises a spray head coupled to the mouth of the main compartment. The coupling mechanism is a friction fit mechanism.

In one aspect, disclosed is a method of storing an accessory in a dispensing bottle, the method comprising providing a dispensing bottle. The dispensing bottle comprising a main compartment having a mouth at a top, a closed base, and a wall, wherein the base and the wall define an inner volume of the main compartment, and a storage compartment comprising a closed base, a wall, and an open top, wherein the closed base and the wall define an inner volume of the storage compartment, the storage compartment is configured to be releasably coupled to a bottom of the main compartment using a coupling mechanism, wherein the closed base of the main compartment closes the open top of the storage compartment, the storage compartment configured to store an accessory. The method further comprises opening the storage compartment from the main compartment; placing the accessory into the storage compartment; and coupling the storage compartment to the main compartment.

### BRIEF DESCRIPTION OF DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a perspective view of a dispensing bottle, according to an exemplary embodiment of the present invention.

FIG. 2 shows a partially exploded view of the dispensing bottle of FIG. 1, according to an exemplary embodiment of the present invention.

FIG. 3 shows another exploded view of the dispensing bottle, according to an exemplary embodiment of the present invention.

### DETAILED DESCRIPTION

Subject matter will now be described more fully hereinafter with reference to the accompanying drawings, which form a part hereof and which show, by way of illustration, specific exemplary embodiments. Subject matter may, however, be embodied in a variety of different forms, and, therefore, covered or claimed subject matter is intended to be construed as not being limited to any exemplary embodiments set forth herein; exemplary embodiments are provided merely to be illustrative. Likewise, a broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe embodiments only and is not intended to be limited to embodiments of the invention. As used herein, the singular forms “a”, “an” and “the” are intended to include the plural forms as well, unless the context indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

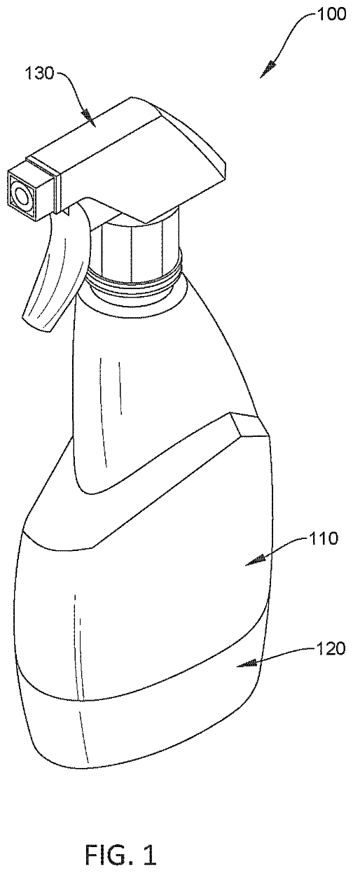

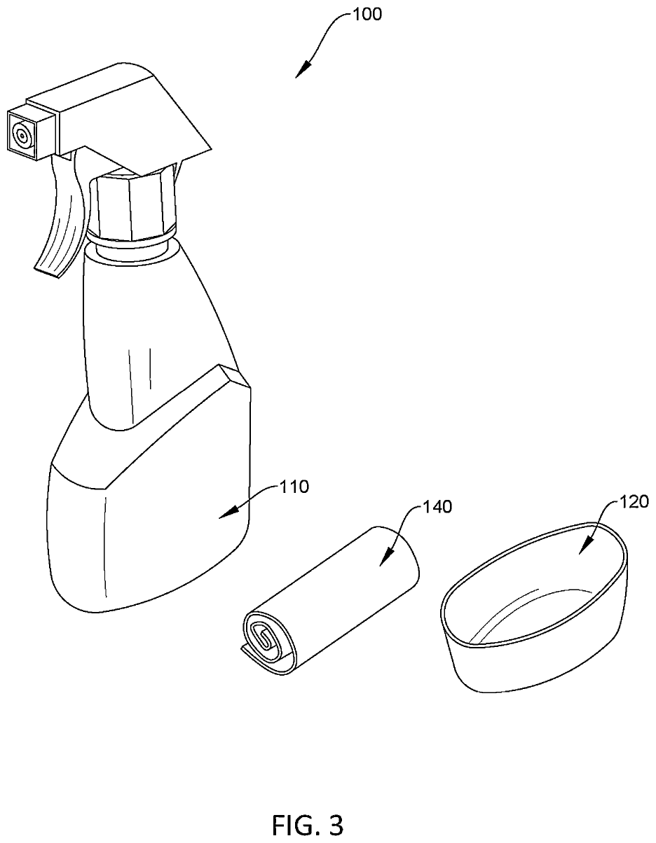

A dispensing bottle is disclosed that can be used to dispense a liquid product. The liquid product can be dispensed in a spray format or can flow from the bottle. Preferably, the dispensing bottle can be of a spray format. Referring to FIGS. 1 to 3 show an exemplary embodiment of the disclosed dispensing bottle. The dispensing bottle in the drawings illustrates a spray bottle.

The dispensing bottle 100 includes a main compartment 110 which may contain the liquid to be dispensed. The main compartment is the primary storage compartment of the dispensing bottle 100 and is typically of a larger capacity. The capacity of the main compartment can be varied and can be manufactured in a range of capacities. A spray head 130 is coupled to an open mouth of the main compartment. The spray head can dispense the liquid contained in the main compartment through its spray nozzle.

The main compartment can be of any suitable shape, such as cylindrical, rectangular, and the like. The size and shape of the main compartment may primarily depend on its application. Preferably, the main compartment can be of an upstanding profile with square, rectangular, elliptical, cylindrical, and like shapes.

The disclosed dispensing bottle may further include a storage compartment 120 disposed at the bottom of the main compartment. The storage compartment may be isolated from the main compartment. The capacity of the storage compartment can be significantly less than that of the main compartment. However, it may be noted that the capacity of the storage compartment can also be varied without departing from the scope of the present present. Like the main compartment, the capacity of the storage compartment may also vary based on intended application or use.

The storage compartment can be coupled to the bottom of the main compartment using a suitable coupling mechanism. For example, the coupling mechanism can be a snap-fit mechanism, wherein the storage compartment can snap-fit to the bottom of the main compartment.

The items or articles of different types can be stored in the storage compartment in an isolated manner. Preferably an accessory for use with the dispensed liquid can be stored in the storage compartment. Examples of such accessories include a piece of cloth, application pad, powder, pouch containing some substance, and the like. For use, the storage compartment can be removed, and the accessory can be taken out from the storage compartment. After use, the accessory can be placed back into the storage compartment and the storage compartment can then be coupled to the main compartment. Thus, the chances of misplacing the accessory after use can be avoided.

The shape of the storage compartment may correspond to the main compartment. Perhaps, the main compartment and the storage compartment in combination may appear as a larger size dispensing bottle. The storage compartment may complement the shape of the main compartment. However, the distinguished or contrasting appearance of the storage compartment relative to the main compartment is within the scope of the present invention.

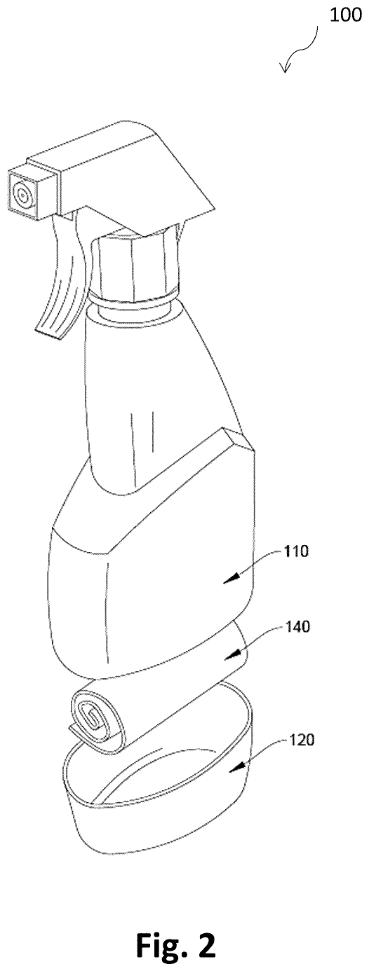

FIG. 2 shows the storage compartment 120 separated from the main compartment 110 and a cloth roll 140 as an accessory is also shown. The storage compartment has a closed base, a side wall, and an open top. The closed base and the side wall may define the inner volume of the storage compartment.

A top portion of the walls of the storage compartment can include the coupling mechanism for coupling the storage compartment to the main compartment. The coupling mechanism can be configured on the inner surface or the outer surface of the walls. The part of the coupling mechanism is disposed on the main compartment and can be configured accordingly. The coupling mechanism that can be used may depend on the size and shape of the main compartment. For example, a screw threads type coupling mechanism may be suitable for a cylindrical-shaped main compartment but not for a rectangular shape main compartment. For the screw thread type fastening mechanism, the main compartment and the storage compartment can have corresponding threads, and the storage compartment can be fastened to the main compartment by turning the same to engage the threads of the storage compartment with those of the main compartment. The number of threads can also be varied; for example, fewer threads may allow quicker coupling, while a greater number of threads may provide structural integrity.

The snap-fit coupling mechanism can be more versatile in that it can be used with different shapes of the main compartment and storage compartment. Another similar coupling mechanism can be a friction fit mechanism.

The dispensing bottle can be made from materials, such as metal or plastic. The material for the main compartment and the storage compartments can be the same or different. Moreover, dispensing bottles can be manufactured in a range of colors and designs.

It is to be noted that the drawings show the storage compartment at base of the main compartment, however, the storage compartment can be disposed in the sidewalls of the main compartment. Also, more than one storage compartment can be provided, for example, one at the base and other at the side wall.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A dispensing bottle comprising:
a main compartment having a mouth at a top, a closed base, and a wall, wherein the base and the wall define an inner volume of the main compartment; and
a storage compartment comprising a closed base, a wall, and an open top, wherein the closed base and the wall define an inner volume of the storage compartment, the storage compartment is configured to be releasably coupled to a bottom of the main compartment using a coupling mechanism, wherein the closed base of the main compartment closes the open top of the storage compartment, the storage compartment is configured to store an accessory.

2. The dispensing bottle according to claim 1, wherein the dispensing bottle further comprises the accessory.

3. The dispensing bottle according to claim 2, wherein the accessory is a roll of cleaning cloth.

4. The dispensing bottle according to claim 1, wherein the dispensing bottle further comprises a spray head coupled to the mouth of the main compartment.

5. The dispensing bottle according to claim 1, wherein the coupling mechanism is a friction fit mechanism.

6. A method of storing an accessory in a dispensing bottle, the method comprising:
providing a dispensing bottle comprising:
a main compartment having a mouth at a top, a closed base, and a wall, wherein the base and the wall define an inner volume of the main compartment, and
a storage compartment comprising a closed base, a wall, and an open top, wherein the closed base and the wall define an inner volume of the storage compartment, the storage compartment is configured to be releasably coupled to a bottom of the main compartment using a coupling mechanism, wherein the closed base of the main compartment closes the open top of the storage compartment, the storage compartment configured to store an accessory;
opening the storage compartment from the main compartment;
placing the accessory into the storage compartment; and
coupling the storage compartment to the main compartment.

7. The method according to claim 6, wherein the accessory is a roll of cleaning cloth.

8. The method according to claim 6, wherein the dispensing bottle further comprises a spray head coupled to the mouth of the main compartment.

9. The method according to claim 6, wherein the coupling mechanism is a friction fit mechanism.
